(19) United States
(12) Patent Application Publication
(10) Pub. No.: US 2007/0150904 A1
(43) Pub. Date: Jun. 28, 2007

(54) Multi-threaded polling in a processing environment

(75) Inventors: Chulho Kim, Poughkeepsie, NY (US); Rajeev Sivaram, West Orange, NJ (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 11/273,733

(22) Filed: Nov. 15, 2005

(51) Int. Cl. G06F 9/46

(52) U.S. Cl. 719/318

(57) ABSTRACT

Processing within a multi-threaded processing environment is facilitated. A plurality of threads are employed to perform polling on a plurality of entities. The polling enables the concurrent driving of progress on the plurality of entities, as well as the detection of occurrence of a specified event across the plurality of entities and the termination of continued polling at the occurrence of this event.

### TECHNICAL FIELD

This invention relates, in general, to facilitating processing within a processing environment, and more particularly, to providing multi-threaded polling in the processing environment.

### BACKGROUND OF THE INVENTION

Polling is a technique used to determine whether a particular event has occurred on one or more entities of a processing environment. In those situations in which there are a plurality of entities, typically, in order to detect whether the particular event has occurred on one or more of the plurality of entities, a processor (i.e., CPU) cycles through the entities polling briefly on each of them. Such a polling technique, however, is limited by the one processor's capability, thus restricting system performance.

Based on the foregoing, a need exists for an enhanced polling capability. In particular, a need exists for a polling capability that adequately provides concurrent polling on a plurality of entities.

### SUMMARY OF THE INVENTION

The shortcomings of the prior art are overcome and additional advantages are provided through the provision of a method of facilitating processing in a processing environment. The method includes, for instance, performing polling on one entity and another entity of the processing environment, the polling including driving progress through the one entity and the another entity concurrently and checking for an occurrence of a specified event on at least one entity of the one entity and the another entity; detecting that the specified event occurred on a particular entity of the one entity and the another entity; and terminating polling on the other entity of the one entity and the another entity, in response to detecting the occurrence of the specified event on the particular entity.

In another aspect of the present invention, a method of facilitating processing in a multi-threaded processing environment is provided. The method includes, for instance, polling by one thread and another thread of the multi-threaded processing environment, the polling driving work to be performed and checking by at least one thread of the one thread and the another thread that a specified event has occurred; detecting by a particular thread of the one thread and the another thread that the other thread of the one thread and the another thread has indicated that the specified event has occurred; and terminating polling on the particular thread that detected the indication of the specified event on the other thread.

System and computer program products corresponding to the above-summarized methods are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one embodiment of a processing environment to incorporate and use one or more aspects of the present invention;

FIG. 2 depicts one example of information stored in a shared location for access by a plurality of entities, such as a plurality of threads, in accordance with an aspect of the present invention;

FIG. 3 depicts one example of an array used to gather status of events for multiple threads of a processing environment, in accordance with an aspect of the present invention;

FIG. 4 depicts one embodiment of the logic associated with the processing of a main thread to facilitate multi-threaded polling, in accordance with an aspect of the present invention;

FIG. 5 depicts one embodiment of the logic associated with the processing of dispatcher threads spawned by the main thread of FIG. 4 to facilitate multi-threaded polling, in accordance with an aspect of the present invention; and

FIG. 6 depicts one example of values of array elements as they change with time during multi-threaded polling, in accordance with an aspect of the present invention.

### BEST MODE FOR CARRYING OUT THE INVENTION

In accordance with an aspect of the present invention, processing is facilitated in processing environments that include a plurality of entities responsible for handling events. An example of such an entity is a communications adapter that handles communications events (e.g., receives messages, sends messages, etc.). However, many other types of entities and/or events are possible without departing from the spirit of the present invention.

Polling is performed for the entities, such that events are driven (e.g., concurrently) across the plurality of entities and the detection of one or more specified events results in termination of polling across the entities.

In one particular example, the polling is performed using multiple threads of the processing environment. Each of the multiple threads executes a polling technique that drives work on its associated entity, as well as on the thread, detects whether a specified event has occurred on its entity or another entity, and terminates polling in response to detecting that the specified event has occurred on its entity or another entity.

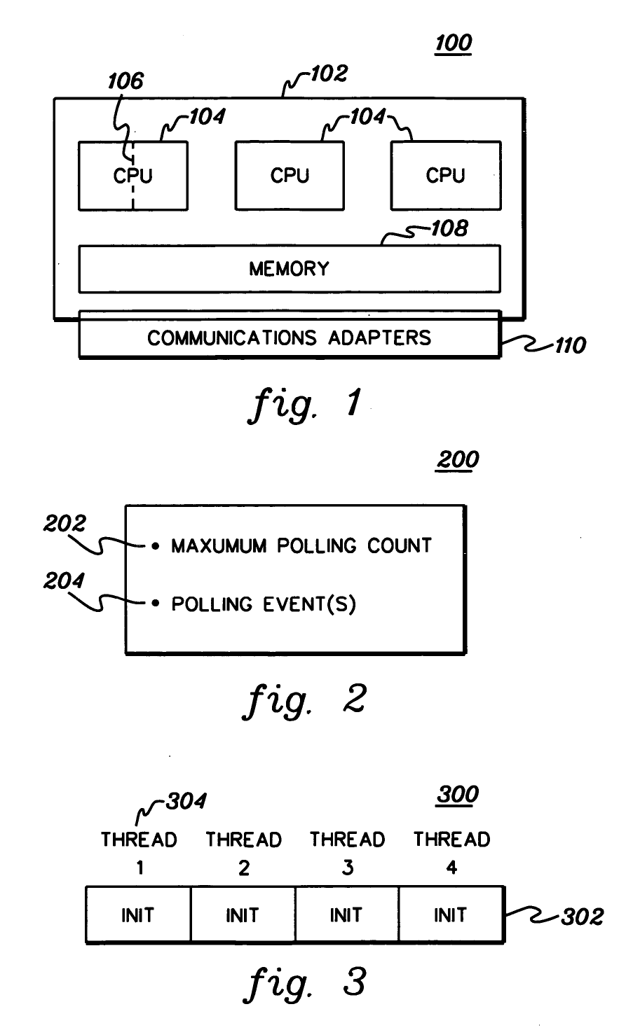

One embodiment of a processing environment incorporating and using one or more aspects of the present invention is described with reference to FIG. 1. In this particular example, a processing environment 100 includes a processing node 102, such as a Pseries server offered by International Business Machines Corporation, Armonk, N.Y., having a plurality of processors 104. The processors are coupled to one another via high-bandwidth connections and managed by an operating system, such as AIX, offered by International Business Machines Corporation, Armonk, N.Y., or LINUX, to provide symmetric multiprocessing (SMP). The multiprocessing is enabled, in this example, by using multiple processing threads, each thread executing on a processor. Further, in one embodiment, one of processors 104 provides multithreading itself, as designated by dashed line 106. That is, this particular processor is capable of executing, in this example, two threads. In other examples, it can execute any number of threads. Similarly, the other processors may also offer a similar feature.

Processing node 102 includes a memory 108 (e.g., main memory) accessed and shared by processors 104. Further, in this embodiment, processing node 102 is coupled to one or more communications adapters 110 used in communicating with various types of input/output devices and/or other devices. An example of a communications adapter is the High Performance Switch (HPS), offered by International Business Machines Corporation, Armonk, N.Y.

In the embodiment described herein, the polling is of the communications adapters, and thus, there is a thread provided for each communications adapter of a plurality of communications adapters. This allows the provision of multi-threaded polling of the plurality of communications adapters, so as to concurrently drive protocol progress in the plurality of communications adapters to improve performance, as well as to quickly detect the occurrence of a specified event (e.g., completion event) across the set of adapters and to break out of continued polling on the occurrence of the completion event. Advantageously, the protocol is able to distribute communication among the adapters in such a way that there is not contention for a common lock among them. This is possible by having, for example, separate communications handles corresponding to each communications adapter, each with its separate communication state and lock.

The threads employed during polling of the communications adapters are referred to herein as dispatcher threads. These threads are spawned from a main thread, in response to a request from a client (e.g., a program, user, etc.) to perform an event, such as send a message, receive a message, obtain information, etc. The main thread is responsible for managing the dispatcher threads and for communicating back to the client.

The main thread provides various information used by the dispatcher threads during polling. For example, the main thread stores in a data structure 200 (FIG. 2) a maximum polling count 202 that indicates a maximum number of times a thread is to poll its corresponding adapter, and a polling events indicator 204 that specifies one or more events for which the threads are to poll. This data structure is stored in a location shared by and accessible to the plurality of threads. For instance, it is stored in main memory 108 (FIG. 1) or in a hardware device coupled to processors 104.

Additionally, the main thread initializes an array of completion state 300 (FIG. 3). The array includes an entry 302 for each of the threads 304 spawned by the main thread (e.g., Threads 1-4). Each of these entries is initially set to the init or null state, as examples.

The information provided in the data structure and the array are used during polling, as described herein. In this example, multi-threading polling of multiple communications adapters is provided. However, in other examples, polling of other entities is provided without departing from the spirit of one or more aspects of the present invention.

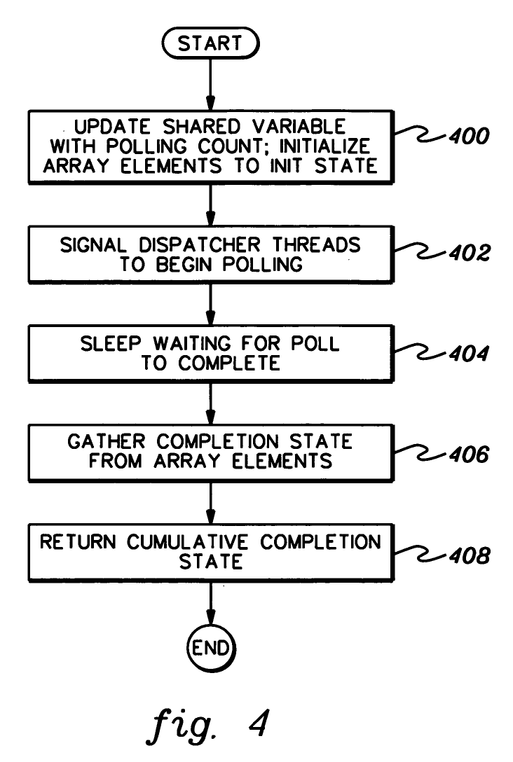

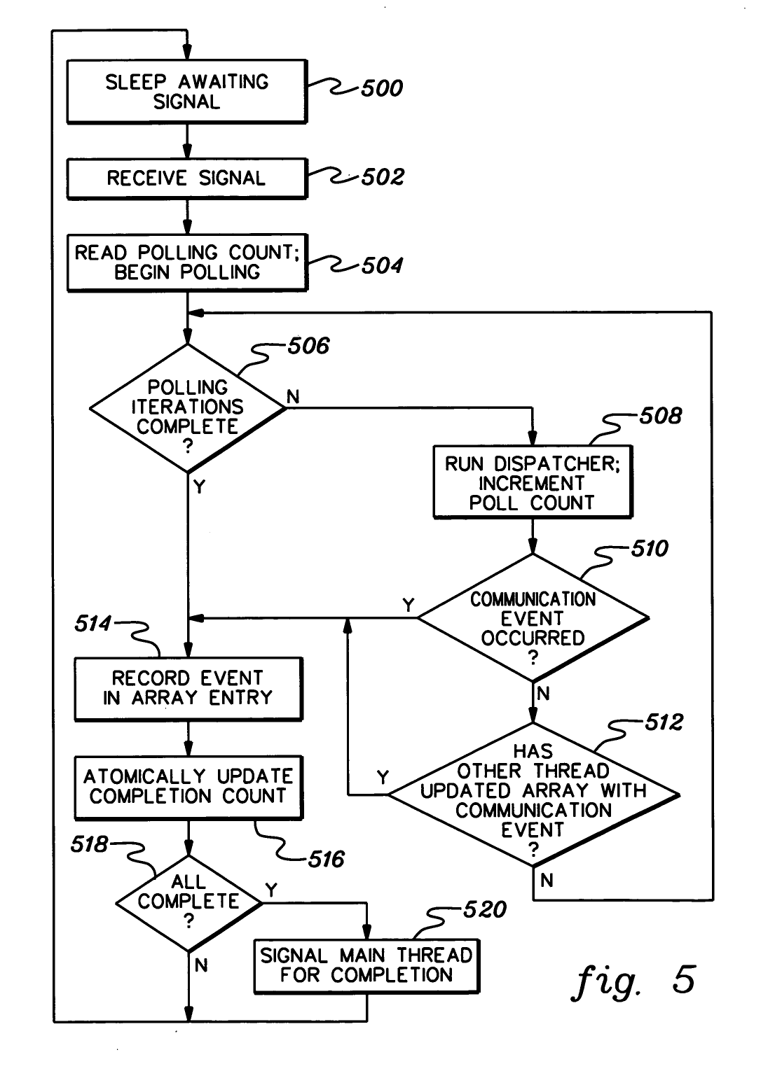

One embodiment of the logic associated with polling is described with reference to FIGS. 4 and 5. Specifically, main thread processing used to initialize polling and manage the completion of polling is described with reference to FIG. 4, and dispatcher thread processing used to perform the polling is described with reference to FIG. 5.

Referring to FIG. 4, a main thread, through which polling is initiated in response to a client request to perform an event, initializes the completion array with an initial state (as depicted in FIG. 3). Further, it stores in the shared data structure (see, e.g., FIG. 2) a count of the maximum iterations for which a dispatcher thread is to poll, and the one or more events for which it is polling, STEP 400 (FIG. 4). Additionally, the main thread signals each of the dispatcher threads to begin polling, STEP 402. This signal is provided in a number of ways including, but not limited to, sending a message, setting a variable checked by the dispatcher thread, etc.

Thereafter, the main thread sleeps until the polling is complete, STEP 404. When the polling is complete, the main thread gathers the completion state from the array elements, STEP 406, and returns the cumulative completion state to the client, STEP 408.

Details associated with the polling are described with reference to FIG. 5. The logic of FIG. 5 is performed by each dispatcher thread spawned by the main thread.

Referring to FIG. 5, a dispatcher thread is initially asleep awaiting a signal to begin polling, STEP 500. In response to receiving the signal, STEP 502, the awoken dispatcher thread reads the maximum polling count from the shared data structure and begins polling, STEP 504. Initially during polling, a determination is made as to whether the number of polling iterations is complete, INQUIRY 506. For example, a count of the number of polling iterations that have been completed by this dispatcher thread is compared with the maximum polling count (e.g., 1000) obtained from the shared data structure. If there are more polling iterations to be performed, then processing continues with running a dispatcher engine and incrementing the polling count, STEP 508.

A dispatcher engine executes within a processor and is responsible for driving events. In this embodiment, in response to executing the dispatcher, a unit of work is performed by the communications adapter coupled to this thread. A unit of work includes the processing of one or more events, in which the number of events to be processed is defined by an administrator, as one example. For instance, in one environment, a unit of work includes sending or receiving a defined amount of a message (e.g., up to 40 or other number of packets).

Subsequent to executing the dispatcher once, in this example, such that one unit of work is performed, a determination is made as to whether one or more specified events have occurred on the communications adapter, INQUIRY 510. Examples of such events include, for instance, a message send completes, a message receive completes, a compound event occurs (e.g., a send and/or receive completes), etc. If a specified event (also referred to herein as a completion event) has not occurred, then a further determination is made as to whether another thread has updated the array indicating that the specified event has occurred on that another thread, STEP 512. If another thread has not updated the array, then processing continues with INQUIRY 506 “Polling Iterations Complete?”.

When the polling iterations are complete, INQUIRY 506, or if a specified event has occurred, INQUIRY 510, or if another thread has updated the array indicating occurrence of the specified event, INQUIRY 512, then processing continues with recording the event in an array entry corresponding to the thread executing this logic, STEP 514. The event recorded depends on what event occurred. For example, if the poll count is complete and no specified event has occurred, then CNT, in one example, is recorded; if a send completion event occurred, then SND, as an example, is recorded; if a receive completion event occurred, then RCV, as an example, is recorded; and if a completion event as seen by another occurred, then OTH, as one example, is recorded.

Subsequent to recording the event, a completion count is updated, STEP 516. The completion count is stored in shared memory and indicates how many of the dispatcher threads have completed. In this example, the completion count is updated atomically, and the update includes incrementing the count by one.

Thereafter, a determination is made as to whether all of the dispatcher threads are complete, INQUIRY 518. This is determined by, for instance, comparing the completion count to the number of spawned dispatcher threads. If all of the dispatcher threads are not complete, then processing continues with sleep awaiting the signal, STEP 500. However, if all of the dispatcher threads are complete, then the main thread is signaled for completion, STEP 520, and processing continues with STEP 500.

As previously described, when the main thread is signaled for completion, it gathers the completion states from the array and returns the cumulative states to the client.

Described in detail above is a polling capability that drives progress of events by enabling concurrent progress to be made on a plurality of entities. In the communications example, for improved communication performance, concurrent progress is made on the adapters by employing multi-threading. The polling described herein also enables the provision of an indication as soon as a specified communications event has occurred. This event may occur on any one (or more) of the adapters (or other entities), and polling ceases on all of the adapters when the event occurs on any one adapter.

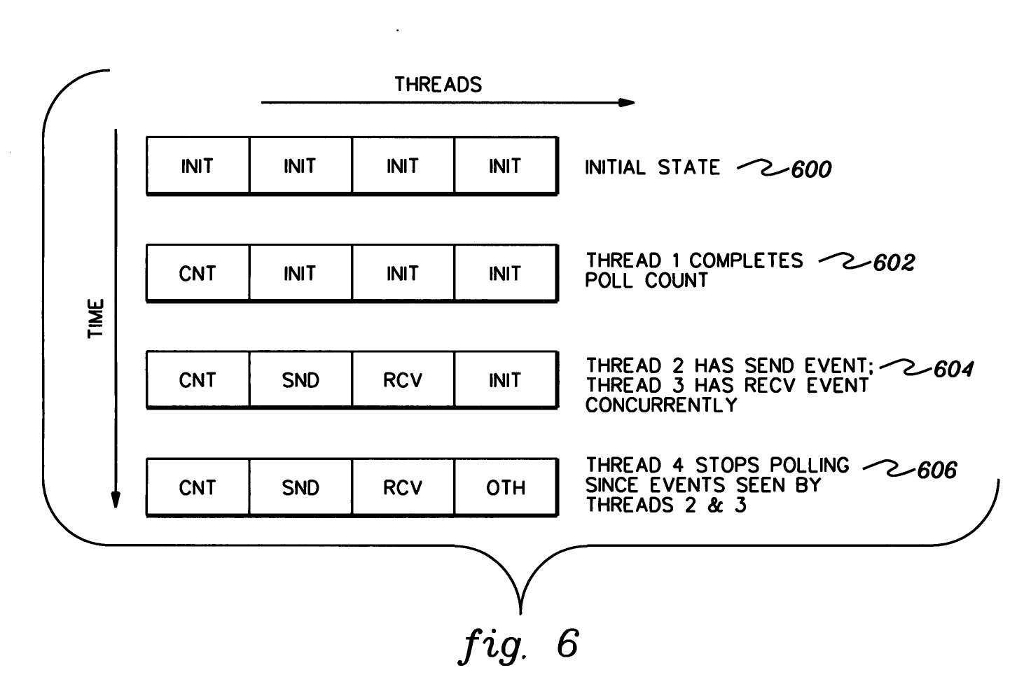

A further example of the polling capability of one or more aspects of the present invention is described with reference to FIG. 6. In this particular example, polling is performed across four communications adapters and the event being polled for is a polling completion event, such as a complete send event or a complete receive event.

Referring to FIG. 6, in response to commencing multi-threaded polling, the main thread initializes each array element to the init state (600), and signals the dispatcher threads to run. Each of the four dispatcher threads, one for each adapter, begins running asynchronously using the flow described with reference to FIG. 5. In this particular example, the first thread runs much faster than the others and finishes its polling count without the occurrence of a specified event. Thus, the thread updates its corresponding array element by setting it to CNT (602) to indicate that it has completed polling without the occurrence of a specified event. It then goes back to sleep waiting for the next multi-threaded poll.

At some later time, a send completion event occurs on Thread 2 and a receive completion event occurs on Thread 3 almost concurrently. These threads record the event that occurred in the corresponding array elements (SND and RCV, respectively) (604), and then go back to sleep waiting the next multi-threaded poll. Thread 4, which has not yet finished its polling count and has not processed a specified event, checks the array elements to find at least one of the other threads (in this example, Threads 2 and 3) has processed a completion event. Therefore, Thread 4 quits polling and records an OTH (606) to indicate that it is quitting because some other thread has seen its polling event.

When Thread 4 completes, the completion count reaches four, causing Thread 4 to wake up the main thread to signal that polling is complete. The main thread looks through the array elements to gather the events that occurred, and in this case, returns a status indication that a send and a receive event completed.

Described in detail above is a capability for facilitating multi-threaded processing, and in particular, multi-threaded polling in a processing environment. In the example described herein, polling is used to concurrently drive progress through a plurality of communications adapters via a plurality of threads and to check for the occurrence of a specified or defined event on at least one of the communications adapters. As used herein, concurrently is defined as at least a portion of work being driven simultaneously through a plurality of communications adapters (or other entities). In one particular implementation, one or more aspects of the present invention are used to perform striping. With striping, concurrent communication over multiple adapters is used to improve communication bandwidth. Striping can be performed in various ways, including, for instance, sending entire messages in parallel over each of the adapters, or distributing fragments of a usually large message among the communications adapters.

Although a particular embodiment is described herein, this is only one example. For example, environments other than those described herein may benefit from one or more aspects of the present invention. Further, changes, additions, deletions etc. to the environment described herein may be made without departing from the spirit of the present invention. For example, one or more processors may be used and/or zero or more of the processors may be able to multithread. Yet further, although a particular number of communications adapters is described herein, this is only one example. One or more aspects of the present invention is usable with any number of communications adapters. Moreover, other entities may be polled and the environment may include no communications adapters or it may include adapters that are not polled. Additionally, although in the embodiment herein, the polling is performed using threads, in other examples, this is not necessary. Further, although a particular number of threads is used herein, again this is only one example. Any number of threads may be used to perform the polling. Yet further, although specific events are described herein as the specified or defined events in which polling is terminated, these events are only examples. Any other events may be used as the completion events. Further, any number may be used as a maximum polling count. Moreover, although the dispatcher engine is described as executing one time and then checks are performed, in other examples, it may be run a different number of times. Many other variations are possible and are considered within the spirit of one or more aspects of the present invention.

Advantageously, in accordance with one or more aspects of the present invention, multi-threading is used to facilitate improved communication efficiency. In one example, data is striped across multiple communications adapters and progress of the striping is driven and monitored by concurrently polling on multiple communications adapters for communications events.

Advantageously, system performance is enhanced by employing one or more aspects of the present invention.

The capabilities of one or more aspects of the present invention can be implemented in software, firmware, hardware or some combination thereof.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating processing in a processing environment, said method comprising:
performing polling on one entity and another entity of the processing environment, said polling comprising driving progress through the one entity and the another entity concurrently and checking for an occurrence of a specified event on at least one entity of the one entity and the another entity;
detecting that the specified event occurred on a particular entity of the one entity and the another entity; and
terminating polling on the other entity of the one entity and the another entity, in response to detecting the occurrence of the specified event on the particular entity.

2. The method of claim 1, further comprising terminating polling on the particular entity, in response to the occurrence of the specified event on the particular entity.

3. The method of claim 1, wherein the performing polling comprises using one thread to poll on the one entity and another thread to poll on the another entity.

4. The method of claim 3, wherein the detecting comprises detecting by the thread of the other entity that the specified event occurred.

5. The method of claim 1, wherein the detecting comprises detecting by a plurality of entities that the specified event occurred and terminating polling on the plurality of entities.

6. A method of facilitating processing in a multi-threaded processing environment, said method comprising:
polling by one thread and another thread of the multi-threaded processing environment, said polling driving work to be performed and checking by at least one thread of the one thread and the another thread that a specified event has occurred;
detecting by a particular thread of the one thread and the another thread that the other thread of the one thread and the another thread has indicated that the specified event has occurred; and
terminating polling on the particular thread that detected the indication of the specified event on the other thread.

7. The method of claim 6, further comprising terminating polling on the other thread, in response to the occurrence of the specified event.

8. The method of claim 7, further comprising informing, in response to terminating polling on the particular thread and the other thread, a client of one or more events that occurred.

9. The method of claim 8, wherein the informing is performed via a main thread, said main thread being responsible for spawning said one thread and said another thread.

10. The method of claim 6, wherein the polling comprises employing the one thread to drive work on one entity of the processing environment and employing the another thread to concurrently drive work on another entity of the processing environment.

11. The method of claim 10, wherein the one entity comprises one communications adapter and the another entity comprises another communications adapter.

12. The method of claim 10, wherein the polling comprises checking by the particular thread whether the specified event has occurred subsequent to driving a defined unit of work.

13. The method of claim 12, wherein the checking is performed subsequent to determining that the specified event has not occurred on a particular entity of the one entity and the another entity on which the particular thread is driving work.

14. The method of claim 13, further comprises driving another defined unit of work and repeating the checking when the checking has not determined that the specified event has occurred.

15. A system of facilitating processing in a processing environment, said system comprising:
means for performing polling on one entity and another entity of the processing environment, said means for performing polling comprising means for driving progress through the one entity and the another entity concurrently and means for checking for an occurrence of a specified event on at least one entity of the one entity and the another entity;
means for detecting that the specified event occurred on a particular entity of the one entity and the another entity; and
mean for terminating polling on the other entity of the one entity and the another entity, in response to detecting the occurrence of the specified event on the particular entity.

16. The system of claim 15, wherein the means for performing polling comprises means for using one thread to poll on the one entity and another thread to poll on the another entity.

17. The system of claim 16, wherein the means for detecting comprises means for detecting by the thread of the other entity that the specified event occurred.

18. A system of facilitating processing in a multi-threaded processing environment, said system comprising:
one thread and another thread of the multi-threaded processing environment adapted to poll, the polling driving work to be performed and checking by at least one thread of the one thread and the another thread that a specified event has occurred; and
a particular thread of the one thread and the another thread adapted to detect that the other thread of the one thread and the another thread has indicated that the specified event has occurred and for which polling is terminated, in response to detecting the indication.

19. The system of claim 18, wherein the one thread drives work on one entity of the processing environment and the another thread concurrently drives work on another entity of the processing environment.

20. The system of claim 19, wherein the particular thread is adapted to check whether the specified event has occurred subsequent to driving a defined unit of work.

21. The system of claim 20, wherein the checking is performed subsequent to determining that the specified event has not occurred on a particular entity of the one entity and the another entity on which the particular thread is driving work.

22. The system of claim 21, wherein the particular thread is further adapted to drive another defined unit of work and to repeat the checking when the checking has not determined that the specified event has occurred.

23. An article of manufacture comprising:
at least one computer usable medium having computer readable program code logic to facilitate processing in a processing environment, the computer readable program code logic comprising:
polling logic to perform polling on one entity and another entity of the processing environment, said polling logic comprising drive logic to drive progress through the one entity and the another entity concurrently and check logic to check for an occurrence of a specified event on at least one entity of the one entity and the another entity;
detect logic to detect that the specified event occurred on a particular entity of the one entity and the another entity; and
terminate logic to terminate polling on the other entity of the one entity and the another entity, in response to detecting the occurrence of the specified event on the particular entity.

24. The article of manufacture of claim 23, wherein the polling logic employs one thread to poll on the one entity and another thread to poll on the another entity.

25. The article of manufacture of claim 24, wherein the detect logic comprises logic to detect by the thread of the other entity that the specified event occurred.

26. An article of manufacture comprising:
at least one computer usable medium having computer readable program code logic to facilitate processing in a multi-threaded processing environment, the computer readable program code logic comprising:
poll logic to poll by one thread and another thread of the multi-threaded processing environment, the polling driving work to be performed and checking by at least one thread of the one thread and the another thread that a specified event has occurred;
detect logic to detect by a particular thread of the one thread and the another thread that the other thread of the one thread and the another thread has indicated that the specified event has occurred; and
terminate logic to terminate polling on the particular thread that detected the indication of the specified event on the other thread.

27. The article of manufacture of claim 26, wherein the poll logic comprises employ logic to employ the one thread to drive work on one entity of the processing environment and to employ the another thread to concurrently drive work on another entity of the processing environment.

28. The article of manufacture of claim 27, wherein the poll logic comprises check logic to check by the particular thread whether the specified event has occurred subsequent to driving a defined unit of work.

29. The article of manufacture of claim 28, wherein the checking is performed subsequent to determining that the specified event has not occurred on a particular entity of the one entity and the another entity on which the particular thread is driving work.

30. The article of manufacture of claim 29, further comprising drive logic to drive another defined unit of work and repeat logic to repeat the checking when the checking has not determined that the specified event has occurred.
